(19) United States
(12) Patent Application Publication
(10) Pub. No.: US 2003/0076587 A1
(43) Pub. Date: Apr. 24, 2003

(54) Confocal theta microscope

(75) Inventors: Ernst H. K. Stelzer, Meckesheim (DE); Thomas Stefany, Leimen (DE); Steffen Lindek, Plankstadt (DE); Jim Swoger, Heidelberg (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(73) Assignee: Carl Zeiss Jena GmbH, Jena (DE)

(21) Appl. No.: 10/303,391

(22) Filed: Nov. 25, 2002

Related U.S. Application Data
(63) Continuation of application No. 09/509,226, filed on Jun. 5, 2000, now abandoned.

(30) Foreign Application Priority Data
Jul. 30, 1998 (DE) 198 34 279.9

(51) Int. Cl. G02B 21/06

(52) U.S. Cl. 359/388; 359/368; 359/385

(57) ABSTRACT

A confocal microscope with separate illumination and detection directions is disclosed. The detection direction in the object is inclined relative to the illumination direction at a predetermined angle which is selected such that the overlapping area of the illumination volume and detection volume is reduced compared to a conventional confocal microscope. A beam splitter or a reflector is provided in the beam path between the objective and an image plane of the microscope for coupling in the illumination light and/or for coupling out the detection light and/or in that the illumination light is coupled into the microscope and/or the detection light is coupled out of the microscope via one or more light-conducting fibers.

This is a Continuation Application under 37 C.F.R. 1.53(b). Priority is hereby claimed under 35 U.S.C. §120 to application Ser. No. 09/509,226, filed Jul. 27, 1999 (35 U.S.C. 371 date of Jun. 5, 2000). The application filed herein also claims foreign priority under 35 U.S.C. §119 to DE 198 34 279.9 filed Jul. 30, 1998 priority to which was claimed in said parent application Ser. No. 09/509,226.

In optical light microscopy, the resolution is defined by the extent of the point spread function, which is a mathematical description of the distribution of electromagnetic energy in the region of the focal point. The smaller the extension of the PSF of a microscope objective, the finer the representation of individual points and, therefore, the better the resolution of the microscope. The resolution along the optical axis, which is poorer than that in the focal plane in all conventional microscopes, is improved by a confocal arrangement (M. Minsky, “Microscopy Apparatus”, U.S. Pat. No. 3,013,567). Nevertheless, even in a confocal microscope, the lateral resolution is generally at least three-times better than the axial resolution. It is known from scientific literature that a further improvement in resolution can be achieved, for example, by reducing the wavelength (C. J. Cogswell and K. G. Larkin, “Handbook of Biological Confocal Microscopy”, second edition, J. P. Pawley, ed., page 128, Plenum Press, New York 1995), by increasing the aperture of the system (S. W. Hell, S. Lindek and E. H. K. Stelzer, J. Mod. Opt., 41, 674, 1994; S. W. Hell, E. H. K. Stelzer, S. Lindek and C. Cremer, Opt. Lett., 19, 222 1994) or by observing the specimen at an angle to the illumination axis (E. H. K. Stelzer and S. Lindek, Optics Comm., 111, 536, 1994).

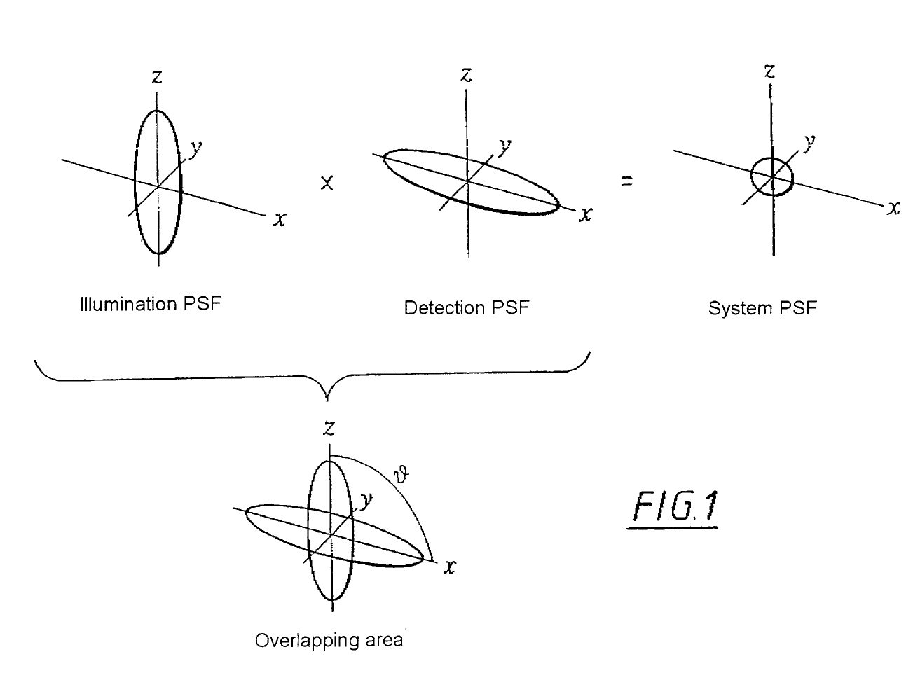

DE 43 26 473 C2 discloses a confocal microscope which is characterized in that it uses a first objective for diffraction-limited point illumination and a second objective for confocal imaging of the object light on a point detector, wherein the detection direction is inclined relative to the illumination direction at an angle which is selected in such a way that the overlapping area of the illumination volume and detection volume is reduced in comparison with a conventional confocal microscope. This microscope, known as a confocal theta microscope, accordingly makes use of the latter method for improvement of resolution and provides an almost isotropic resolution. FIG. 1 shows a confocal theta microscope of this kind with angle θ not equal to 0 between the axis for illumination of the specimen and the axis for detection of the emitted light. The illumination is carried out along the z-axis and the resulting PSF is extended in this direction. The detection PSF is extended along the x-axis in the same way. Both PSFs overlap in the area of the common focal point. Only in this overlapping area are points illuminated and their emission detected. When the angle ′ between the illumination axis and the detection axis equals 90°, the overlapping area is almost spherical, which means that the resolution is comparable in all three spatial directions. The extension of the entire PSF formed of the product of the illumination PSF and the detection PSF is reduced to a minimum, which is synonymous with an improved resolution of the microscope.

It is likewise known from DE 43 26 473 C2 that, in order to improve resolution, confocal theta microscopy can also be combined with dual-confocal microscopy, known from DE-OS 40 40 441, which is also referred to in the literature as 4Pi confocal microscopy. Four Pi confocal microscopy increases the numerical aperture of a confocal microscope and accordingly improves the axial resolution (S. Hell and E. H. K. Stelzer, J. Opt. Soc., Am. A., 9, 2159, 1992). In the technique referred to in scientific literature as 4Pi(A) confocal microscopy, the specimen is illuminated coherently by two convergent beams propagating opposite to one another. The interference of these two beams reduces the half width of the principal maximum of the illumination PSF. In the technique known as 4Pi(B) confocal microscopy, the interference originates at the detection diaphragm and accordingly reduces the extension of the detection PSF. The method known as 4Pi(C) confocal microscopy combines these two techniques.

When the confocal theta microscopy known from DE 43 26 473 C2 is combined with the 4Pi confocal microscopy known from DE-OS 40 40 441, the specimen is illuminated as in a 4Pi(A) confocal microscope and the emitted light is detected orthogonally as in a confocal theta microscope, so that the axial secondary maxima of the PSF are suppressed. This means that the emission is not detected outside of the focal plane in 4Pi illumination.

Conventionally, confocal theta microscopy is realized in such a way that two (or more) objective lenses are arranged at an angle α (S. Lindek, R. Pick and E. H. K. Stelzer, Rev. Sci. Instrum., 65, 3367 1994). Although this is the obvious arrangement for theta microscopy, it requires separate beam paths for illumination and detection and therefore approximately twice the quantity of optical components.

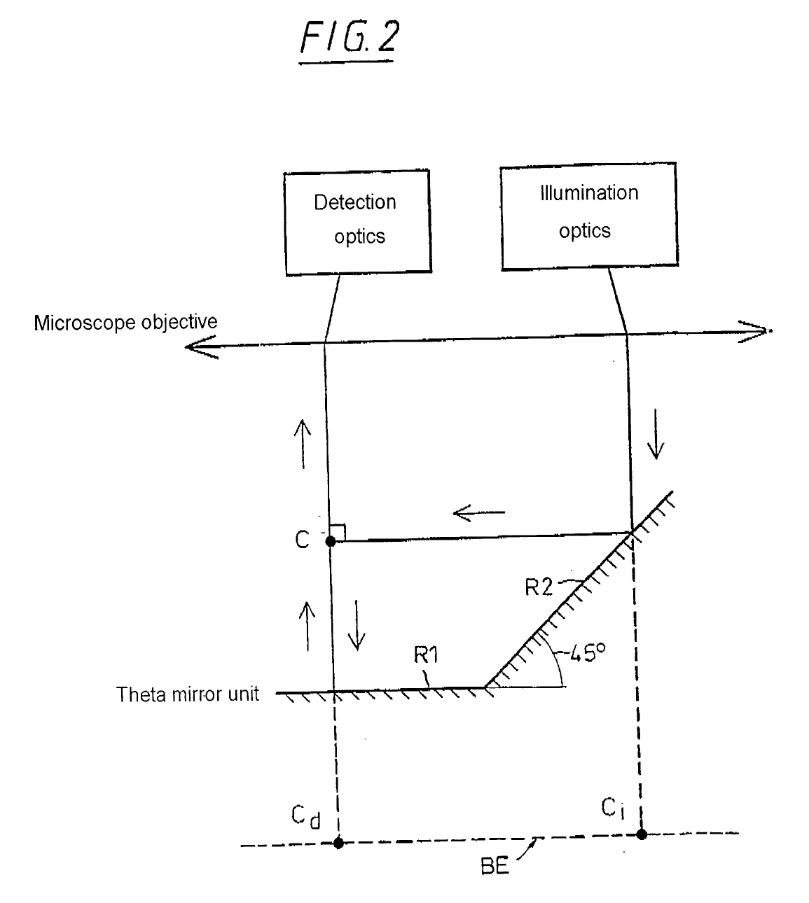

It is known from DE-OS 196 32 040 A1 and WO 98/07059 that the principle of confocal theta microscopy can also be realized with a single microscope objective. Such a device, known as a single-lens theta microscope SLTM, avoids the complexity associated with dual-objective systems such as those known from DE 43 26 473 C2, DE-OS 196 29 725 A1 and WO 98/03892. FIG. 2 shows the way such SLTMs work. The combination of an objective lens and a beam deflecting unit, known as a theta mirror unit, between the objective of the microscope and its focal plane BE allows imaging of the specimen from different angles. The illumination light passes through the objective lens and forms the virtual focal point Cᵢ below the 45-degree mirror. The reflection at the surface of the 45-degree mirror guides the light horizontally to focal point C which is located inside the object to be observed. In contrast, the detection optics collect only the light of the virtual image C_{d} which is formed by the horizontal mirror. Therefore, the detection axis is vertical and the illumination and detection axes accordingly form an angle of 90°. The alignment of the two mirror surfaces is selected in such a way that the images Cᵢ and C_{d} of C lie in the focal plane of the objective and are imaged confocally in the illumination optics and detection optics.

The beam path in a conventional confocal microscope must be changed in order to operate it as an SLTM. These changes are preferably carried out in such a way that the microscope can continue to be operated also in the conventional confocal mode. In particular, a special modification of the illumination device is necessary for a 4Pi illumination.

Through the present invention, a way has been discovered for carrying out the changes in a conventional confocal microscope. For this purpose, it is suggested according to the invention that the light is coupled in and/or coupled out by means of a beam splitter or reflector located between the objective and an image plane of the microscope and/or that the coupling in and/or coupling out is carried out via light-conducting fibers.

An embodiment example of the present invention will be explained more fully in the following with reference to the drawings.

A preferred embodiment form of the microscope according to the invention is based on a Zeiss Axioplan universal microscope (Model 1) in which the reflector slide (arranged between the tube and the objective lenses of the microscope) has been modified in such a way that light can be coupled into and out of the device by means of one or more light-conducting fibers. Despite additional external parts, only the slide is modified, so that the original function of the Axioplan is retained. The following types of microscopy are possible with this system: 1) traditional wide-field microscopy; 2) confocal laser scanning microscopy (LSM) (through system modifications not described herein); 3) confocal theta microscopy; and 4) 4Pi confocal theta microscopy. In theta microscopies, object scanning is applied in order to represent spatially extended structures.

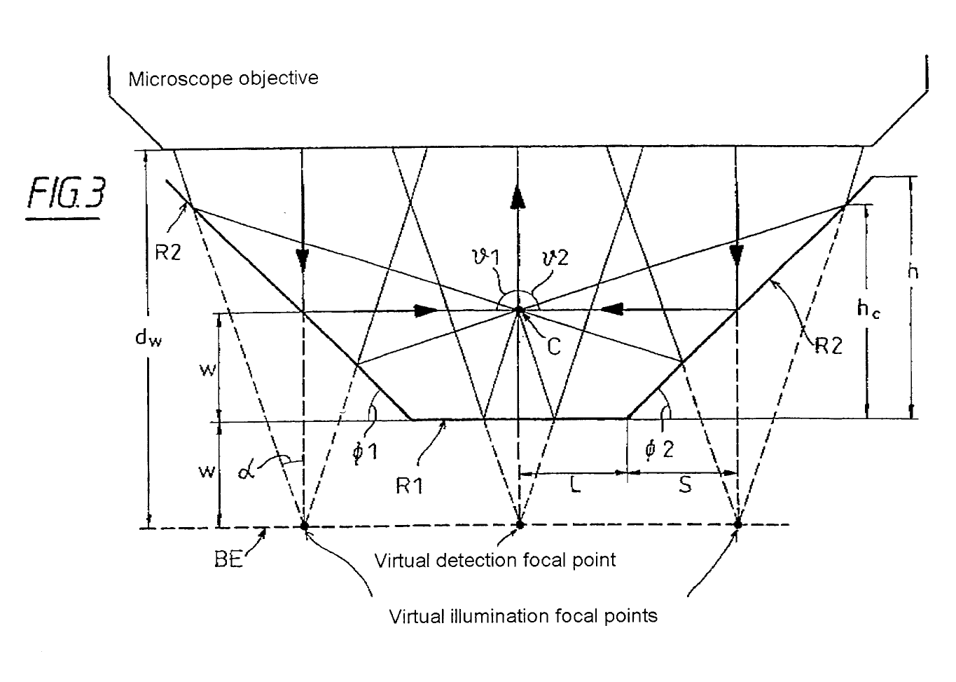

FIG. 3 shows the objective, the theta mirror unit and the illumination and detection beam paths of the SLTMs. A single objective lens focuses the illumination light and detection light on three points in the virtual image plane. This system differs from the embodiment form in FIG. 2 in that the theta mirror unit has three portions: a horizontal mirror R1 and two tilted mirrors R2 at angles φ₁ and φ₂ to the horizontal. This affords optimal access to the specimen from three different directions. The two outer beam paths are used for illumination, so that a 4Pi illumination can be achieved, and the middle beam path is used for observation of the specimen.

The angles of the mirror components are preferably selected in such a way that φ₁=φ₂=45° and θ₁=θ₂=90°. This means that 1) detection is oriented vertical to the illumination (resulting in an overlapping area of the illumination PSF and detection PSF with almost spherical symmetry) and 2) the illumination beams in 4Pi illumination run in opposite directions (minimizing of the distance between the interference nodal points in the region of focal point C). Therefore, the symmetric system where φ₁=φ₂=φ=45° will be considered in the following.

For SLTM, an objective lens and the dimensions of the theta mirror unit must be selected. In FIG. 3, the working distance d_{w} and the maximum aperture angle α are determined by the objective. Angle α is defined as follows:

α=sin⁻¹(NA/nᵣ).

NA is the numerical aperture of the objective and nᵣ is the index of refraction of the immersion medium. Ideally, both d_{w} and α are as large as possible, but in conventional objectives the working distance in many cases decreases with the numerical aperture. Taking into consideration the intended use of the system by the Applicant (e.g., as a fluorescence microscope for biological specimens), a 63° Zeiss Achroplan water immersion objective (Carl Zeiss Jena, Germany) with d_{w}=1.46 mm and NA=0.9 was selected, by which an aperture angle of α=42.6° in water is achieved.

In order to fully specify the theta mirror unit, the following parameters must be determined: the distance w of the horizontal mirror from the focal plane BE; the distance L from the middle of the mirror unit to the inner edge of the 45-degree mirror; the horizontal distance s from the inner edge of the 45-degree mirror to the central axis of the illumination beam path; and the mirror height h. Let φ=45°, then

L=s=w

in FIG. 3. Therefore, only L and h need to be determined in order to determine the configuration of the required theta mirror unit.

The height of the theta mirror unit is limited such that it must be less than the working distance of the objective, i.e., h<hₘₐₓ=d_{w}−L. With a value of h=1.0 mm for the mirror height, which is less than the working distance d_{w}=1.46 mm, some space remains between the objective and the upper edge of the theta mirror unit.

Parameter L stands for the shortest distance between the theta mirror unit and focal point C and represents the greatest distance from which an object in the system can be scanned vertically.

Although a greater value of L is advantageous, there are two other functions aside from d_{w} which limit L in practice. If the incident light in its entirety is to reach focal point C, both virtual illumination focal points must lie in the focal plane in the field of view of the objective. If the distance between the virtual illumination focal points in the object plane equals 4L, their distance in the focal plane is 4M_{obj}L, where M_{obj} is the magnification of the objective (see FIG. 3). Thus, in order for the microscope to display both focal points at the same time, the distance between the two focal points must be less than the field diameter φ_{f}, so that

L<φ_{f}/4M_{obj}.

For the selected objective, φ_{f}=20 mm and M_{obj}=63, so that L<79 μm with 4Pi illumination in this system.

The other factor influencing the selection of L is h_{c}, the maximum height at which the outer light cone strikes the surface of the 45-degree mirror (see FIG. 3). In general, h_{c} is proportional to L; in particular, h_{c} is approximately 1.9 mm in this system. It should be clear that the entire light cone is not deflected to focal point C when h_{c}>h, and some of the optical energy is lost. Under certain circumstances, this loss can affect the output of the microscope, but in the present case L<79 μm causes an output loss of less than 0.8%, so that L=75 μm is an advantageous choice for this system.

The outputs of the two polarization-preserving light-conducting fibers (PP fibers) are placed in such a way that the laser light can be directed to the observation object via the outer beam paths (see FIG. 3). A multimode light-conducting fiber (MM fiber) is located in the central beam path and collects the scattered or fluorescent light of the observation object.

In order to realize this arrangement, the standard mirror slide of an Axioplan microscope was modified, this mirror slide being located between the objective and the tube lens. It was advantageously changed in such a way that one of its four openings is used for the SLTM. Other slides can also be used for this purpose. In other microscope models, there is also the possibility of attaching light-conducting fibers to the microscope stand.

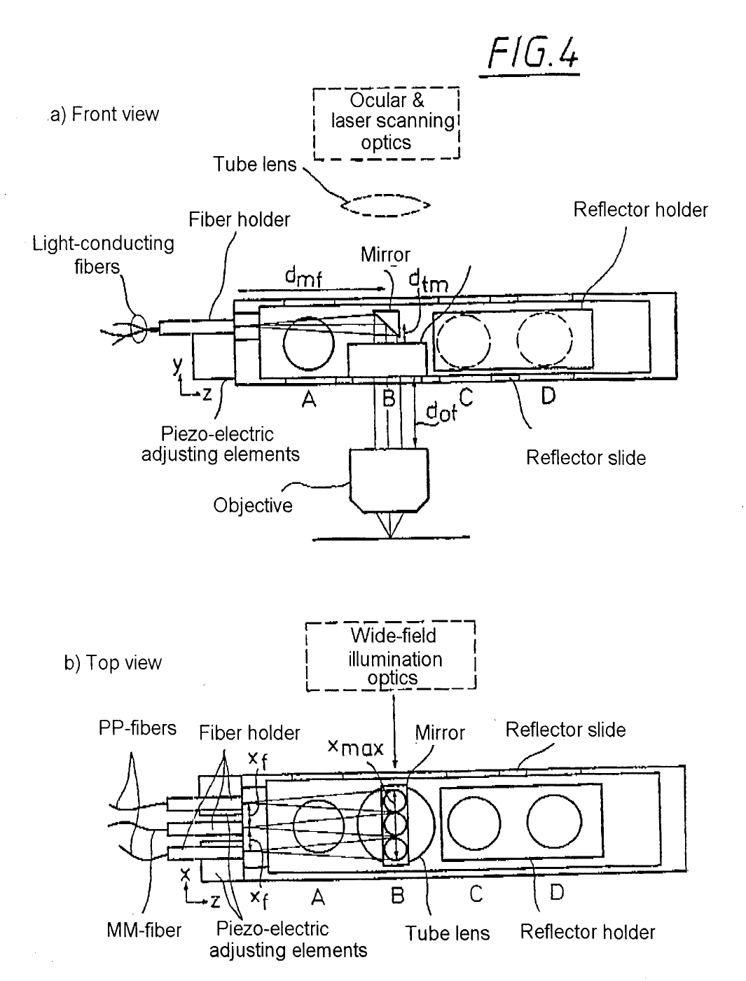

FIG. 4 shows a schematic view of the mirror slide and the adjoining optics. The slide and the structural component parts connected therewith are shown in a front view and in a top view. In the standard configuration of the Axioplan, the light coming from the observation object falls through one of the four holes (A-D) in the slide which can be moved laterally between the objective and the standard tube lens. After this, it either falls through the upper part into the ocular or through the back diaphragm into the detection optics. In the modified system, positions C and D continue to function according to the principle just mentioned. Position B is used for the connection of the light-conducting fibers and A remains empty so as not to block the beam path to the light-conducting fibers. This empty position is used in the confocal LSM mode of the system in which the light is coupled into and out of the Axioplan via the video port.

The combination of objective lens and the changes carried out in position B of the slide advantageously lead to a telecentric imaging system. This is constructed in such a way that it collects the light from the virtual focal points in the objective focal plane and projects their magnified images onto the light-conducting fibers in the image plane.

The focal length of the standard tube lens of the Axioplan (f_{t,standard}=164.5 mm) and its distance from the objective base (100.5 mm) show that the back focal plane of the objective is located 64 mm below the stop of the objective. With this assumption and the fact that the distance from the stop of the objective to the tube lens dₒₜ is 36.3 mm, the focal length of the new tube lens must be 100.3 mm for a telecentric configuration of the arrangement shown in FIG. 4.

Taking into account the limiting of aberrations, the tube lens selected was a Melles Griot Dapromat hybrid lens having a focal length fₜ=100 mm and a diameter of 26.5 mm. With these parameters, it was possible to determine the position and size of the image point imaging that had to be matched to the light-conducting fibers.

The position of the image plane defined by the distance of the tube lens from the mirror dₜₘ and the distance of the mirror from the fiber d_{mf} in FIG. 4 is determined by the relationship dₜₘ+d_{mf}=fₜ. In order to integrate the components into the mirror slide, the value of 4.6 mm was set for dₜₘ, so that d_{mf} is 95.4 mm. The focal length fₒ of the Axioplan for any observation object is:

fₒ=f_{t,standard}/M_{obj}.

With the 63× objective used in this case, a focal length of 2.61 mm results. The effective magnification of the modified system is therefore M_{sys}=38.3.

Since the distance between the virtual focal points in FIG. 3 is 2L=150 μm, the light-conducting fibers must be positioned such that x_{f}=5.57 mm in order to have them at the confocal points of the system.

The maximum spatial extension is between the optical beams (xₘₐₓ in FIG. 4) at the tube lens and is xₘₐₓ=16.3 mm. Since this value is less than the optical diameter of the tube lens (23.9 mm), the aperture in the optical beam path is not limited by the tube lens.

The illumination light-conducting fibers for this work are, for example, Panda type PP light guides (#WT-01-PGA-213-70C-005, WaveOptics Inc., Mountain View, Calif. USA) with a field diameter of 3.5 μm, a boundary wavelength of less than 470 nm and NAₚₚ of 0.11. This numerical aperture achieves a maximum beam width of 22 mm which is considerably greater than the objective aperture φ_{obj}=4.8 mm. Therefore, the objective is over-illuminated, so that it may be assumed that the field is homogeneous over the entire back focal plane.

For the present calculations, the PSF is treated as diffraction-limited. This means that the diameter is approximately:

φ_{image}=M_{sys}1.22λ/NA_{obj},

where λ is the wavelength of the light. Assuming an average wavelength of −525 nm, the image diameter is φ_{image}=27.6 μm, which defines the optimal size of the detection pinhole of the system. In order to avoid an extra pinhole, a quartz MM light-conducting fiber (NAₘₘ=0.22, 230 nm<λ<1100 nm, 25 μm core, BTO Bungert GmbH, Weil der Stadt, Germany) with a fiber core diameter adapted to φ_{image} was selected as detection light-conducting fiber. Since the numerical aperture of this fiber NAₘₘ is greater than that of the tube lens, the light-conducting fiber is capable of collecting all of the light available for detection.

The exact positioning of the three fibers in the image plane of the tube lens is important for the successful operation of the SLTM. The fibers must always be arranged relative to one another and to the theta mirror device in a precise manner. The MM light-conducting fiber is advantageously fastened directly to the modified mirror slide, so that it serves as a fixed reference point.

The theta mirror device can then be positioned with reference to this reference point by operating the control elements for the xyz-positioning at the object table of the microscope on which it rests.

As is shown in FIG. 4, the PP light-conducting fibers are advantageously fastened to translational adjusting elements. In the above-mentioned embodiment example, the fibers are fastened to triaxial piezo-electric position holders (Minitritor 3D MIN 38 NV, Piezsystem Jena GmbH, Jena, Germany) which allows a movement of 38 μm in every direction. This permits spatial positioning of the illumination fibers relative to the MM fibers with an accuracy in nanometers. A rough adjustment of all three fibers can be carried out by means of the screws which fix the fibers to the mirror slide.

In order to achieve an optimal output with 4Pi confocal theta microscopy, it is important that the central maximum of the illumination PSF agrees with the maximum of the detection PSF. The phase control necessary for this purpose is realized by adjusting the axial position of one or both PP fibers with translational adjusting elements, for example, piezoelectric actuators.

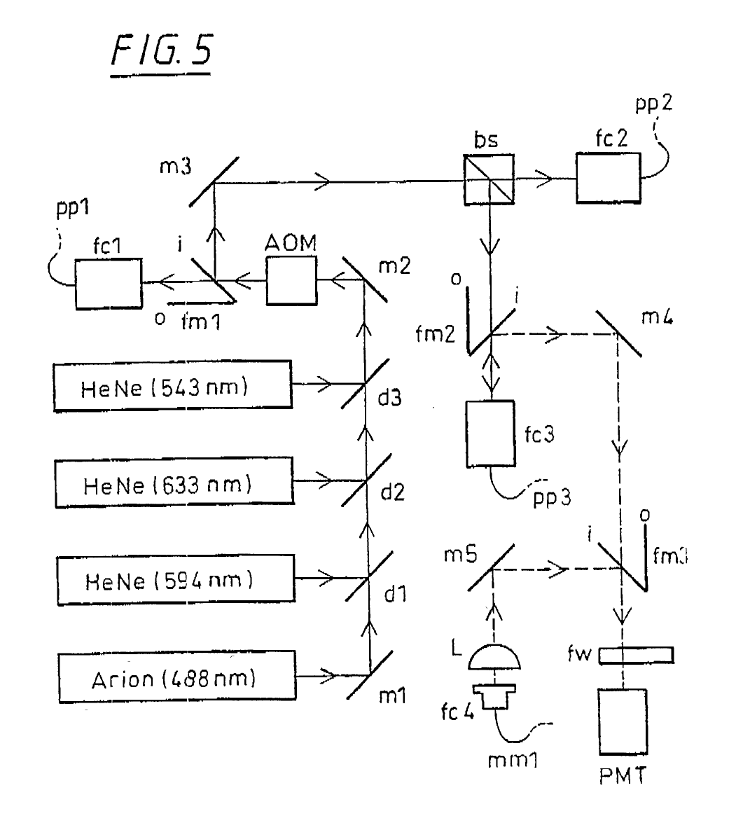

FIG. 5 shows a schematic diagram of the illumination elements and detection elements of the SLTM which are located outside the Axioplan microscope. The direction of light propagation is indicated by the arrows. The illumination beam paths are shown by solid lines and detection is indicated by broken lines. The lasers are an argon-ion laser (Model 2014, Uniphase Vertriebs GmbH, Eching, Germany) which delivers a line at 488 nm, and three HeNe lasers (Model LHRP-1701, LHYP-0101, LHGP-0101, Research Electro-Optics, Inc., Boulder, Colo., USA) for wavelengths of 633 nm, 594 nm and 543 nm, respectively. The entire arrangement is arranged on a vibration-isolated optical table.

The light of the four lasers is bundled by the dichroic mirrors d1-d3 to form a single beam which is then guided into the AOM (acousto-optic modulator: AA.AOTF.4C-T and AA.MOD.4C.230 VAC, A.A. Opto-Electronic, St.-Rémy-les-Chevreuse, France). This is capable of modulating the energy of more than six wavelengths, so that the energy of every individual wavelength of the illumination beam can be controlled.

The light beam coming out of the AOM can either be fed directly into the first fiber coupler fc1 or deflected to the beam splitter through a tilting mirror (Owis GmbH, Staufen i. Br., Germany) fm1 and mirror m3. To work in the confocal laser scanning mode, fc1 couples the light into the PP fiber pp1.

In (4Pi) confocal theta microscopy, fm1 is introduced into the beam path and the light beam coming from the AOM is conducted to the 50:50 nonpolarizing beam splitter bs (broadband hybrid cubic beam splitter 03 BSC 005, Melles Griot GmbH, Bensheim, Germany). The partial beams are coupled into fibers pp2 and pp3 via fc2 and fc3 (with fm2 OUT). These are used as illumination sources for the (4Pi) confocal theta microscopy.

The MM fiber mml is used with fm3 IN to couple the emitted light out of the Axioplan in the confocal theta mode. The light exiting from this fiber (which ends at the dividing adapter fc4) is collected by the lens L (f/l, 25 mm diameter, plano-convex, antireflection-coated for visible light) and deflected by mirrors m5 and fm3 (IN position) to the filter wheel fw which passes only the relevant emission signals. The light penetrating through these filters is received by the PMT (photosensor module, H5702-50, Hamamatsu Photonics Deutschland GmbH, Herrsching, Germany).

In order to make use of the present system in the laser scanning mode, it is necessary that fm1 is in the OUT position, so that the laser light is transmitted via pp1 to the observation object.

In the confocal theta mode of the system, fm1, fm2 and fm3 must be in the IN position. In this way, it is made possible that the light is coupled into pp2 and the signal is received by mml. With fm2 IN and fm3 OUT, the light can also be guided out of pp3 into the PMT.

The configuration for 4Pi confocal theta microscopy is similarly set up, except that fm2 is in the OUT position, so that both pp2 and pp3 can be used as illumination sources. The laser scanning optics and detection optics are not used in the SLTM configuration.

The specimen is held by a capillary which is fastened to a precision scanning table (Model P-762.00, Physik Instrumente, Waldbronn, Germany) which has a movement span of several millimeters and can be scanned in all three directions over an area of 20 μm with an accuracy of better than 40 nm. The capillary is horizontally aligned and is inserted between the objective lens and the theta mirror unit in order to hold the object in position C (see FIG. 3). The capillary is preferably rotated, so that the observation object is located below it and it causes minimal blockage of the beam path.

The theta microscope is controlled by an IBM-compatible computer which contains cards for controlling the step motors in the filter wheel, the D-A converters (PCI-20098C, Burr-Brown/Intelligent Instrumentation, Tucson, USA) which drive the object table, and the amplification regulating means for the PMT. A-D converters (PCI-20098C, Burr-Brown/Intelligent Instrumentation, Tucson, USA) are used to record the light intensity received by the PMT. The drive units of the tilting mirrors and piezo adjusting elements for the fibers can be controlled via the computer, but can also not be connected with the computer and can be controlled manually via the corresponding drive units (PS1612 power supply, Monacor and E-101-01 piezo adjusting elements power supply, Piezosystem Jena GmbH).

A program written in Visual Basic (Microsoft Corp., Redmont, USA) manages the data acquisition. In this process, the computer generates three values for an xyz-address which positions the observation object relative to the objective and the theta mirror unit. The positioning is controlled by an electronic structural component part (Model P-925.272, PI Physik Instrumente, Waldbronn, Germany) which works in a closed loop. The intensity of the light emitted from the observation object is measured via a PMT as a function of the focus position in the object.

The arrangement described above allows several microscopy methods:

1) Conventional wide-field reflection and transmission microscopy is possible with the Axioplan without modifying its construction. The observation object can be illuminated either from above with a mercury vapor lamp for reflection or fluorescence or from below with a halogen lamp for transmission.

2) Confocal laser scanning microscopy can be carried out. In this case, illumination light and detection light share the same beam path through the objective lens and the respective mirror arrangement. Illumination light is made available through light-conducting fibers (pp1 in FIG. 5) and fluorescent light falls through filters into detectors which are not described more fully herein.

3) SLTM is possible by applying the modifications to the Axioplan which are described herein.

The system can also be operated as a 4Pi confocal theta microscope. This mode is very similar to the SLTM configuration with the exception that the observation object is illuminated coherently from at least two sides. The interference pattern formed by these two beams propagating against one another reduces the size of the illumination PSF and thus improves the resolution of the system.

By combining all methods in one device, it is possible for the user to switch back and forth between the different operating modes and to select the most suitable methods for the user's examination. For example, initial observation of an object can be carried out with the wide-field or confocal laser scanning method. Since the complexity of adjustment increases with increasing sensitivity of the methods, the user need only apply the simplest microscopy mode that can display the relevant characteristics.

The design of the present instrument is suited to biological research. The use of water as immersion medium makes it possible to observe biological specimens in their natural environment. The shorter free working distance in comparison to confocal theta microscopy with two objective lenses means that the specimens need not be as large as they must be in the latter case. Therefore, SLTM has the greatest importance as a tool for cellular and sub-cellular biological research. The use of water immersion objectives also has the advantage that aberrations due to different refractive indices are minimized.

The best possible resolution is approximately 100 nm in the 4Pi confocal theta mode compared with 200-350 nm in confocal theta microscopy and approximately 1400 nm in the confocal laser scanning mode.

Key to Reference Numbers

FIG. 2

C focal point

C_{d} virtual detection focal point

Cᵢ virtual illumination focal point

R1 horizontal reflector

R2 oblique reflector

FIG. 3

α half aperture angle of focused beam

φᵢ angle of inclination of mirror

′ᵢ theta angle

h height of theta mirror unit

h_{c} critical mirror height

L horizontal distance of the base of the tilted mirror from the center axis

s horizontal distance of the illumination focal point from the base of the tilted mirror

w vertical distance of the horizontal mirror from the common focal point

d_{w} free working distance

FIG. 4

d_{mf} distance of the fibers from the tube lens

dₜₘ distance of the tube lens from the mirror

dₒₜ distance of the tube lens from the objective

x_{f} distance of the fibers from one another

xₘₐₓ maximum extension of the illuminated field to the mirror

Distances dₜₘ and dₒₜ which define the position of the new tube lens relate to the principal planes of the lens and not to its physical dimensions.

FIG. 5

AOM acousto-optic modulator

bs beam splitter

di dichroic mirror

fci fiber coupler

fmi tilting mirror

fw filter wheel

L lens

mi mirror

mml multimode light-conducting fiber

PMT photomultiplier tube

ppi polarization-preserving light-conducting fiber

1. Confocal microscope with separate illumination and detection directions, wherein the detection direction in the object is inclined relative to the illumination direction at a predetermined angle which is selected such that the overlapping area of the illumination volume and detection volume is reduced compared to a conventional confocal microscope, characterized in that a beam splitter or a reflector is provided in the beam path between the objective and an image plane of the microscope for coupling in the illumination light and/or for coupling out the detection light and/or in that the illumination light is coupled into the microscope and/or the detection light is coupled out of the microscope via one or more light-conducting fibers.

2. Confocal microscope according to claim 1, characterized in that a single microscope objective according to DE-OS 196 32 040 is used for illuminating at least one object point and for confocal imaging of the object light onto at least one detector in order to realize the optical principle described in claim 1, and in that a beam-deflecting unit arranged on the object side of the objective directs the illumination light onto the object and the object light in the direction of the objective.

3. Confocal microscope according to claim 1, characterized in that, in order to realize the optical principle described in claim 1, it has a dual objective according to DE 196 29 725 which comprises an illumination objective for illuminating at least one object point and a second, detector objective for confocal imaging of the object light onto at least one detector.

4. Confocal microscope according to at least one of the preceding claims, characterized in that the beam splitter or reflector is located between the objective and tube lens.

5. Confocal microscope according to at least one of the preceding claims, characterized in that the beam splitter or reflector is located in the reflector slide of the microscope.

6. Confocal microscope according to at least one of the preceding claims, characterized in that the light-conducting fibers for coupling in and/or coupling out light are arranged linearly (horizontally, vertically or diagonally) or in an optional pattern.

7. Confocal microscope according to at least one of the preceding claims, characterized in that a tube lens is used between the light-conducting fibers and the beam splitter or reflector.

8. Confocal microscope according to at least one of the preceding claims, characterized in that the system of light-conducting fibers, tube lens, beam splitter or reflector, and objective is arranged telecentrically.

9. Confocal microscope according to at least one of the preceding claims, characterized in that the light-conducting fibers are fastened to the reflector slide.

10. Confocal microscope according to at least one of the preceding claims, characterized in that the light-conducting fibers are fastened to the microscope stand.

11. Confocal microscope according to at least one of the preceding claims, characterized in that the light-conducting fibers can be moved by means of translational adjusting elements.

12. Confocal microscope according to at least one of the preceding claims, characterized in that the light-conducting fibers can be displaced along their axis by translational adjusting elements in order to change the phase of the light passing through them in every point in the surrounding area of the focal point in such a way that it assumes a determined value.

13. Confocal microscope according to at least one of the preceding claims, characterized in that the phase of the light can be maintained constant in every point in the surrounding area of the focal point.

14. Confocal microscope according to at least one of the preceding claims, characterized in that the detector fiber is fixedly mounted and is used as a reference for the adjustment of the other fibers.

15. Confocal microscope according to at least one of the preceding claims, characterized in that a reference diode is used for measuring the illumination intensity behind the beam splitter according to claim 1.

16. Confocal microscope according to at least one of the preceding claims, characterized in that each of the light-conducting fibers can be used for illumination and/or detection as selected.

17. Confocal microscope according to at least one of the preceding claims, characterized in that the reflector slide is exchangeable.

18. Confocal microscope according to at least one of the preceding claims, characterized in that the reflector slide has additional elements.

19. Confocal microscope according to at least one of the preceding claims, characterized in that the beam-deflecting unit arranged on the object side of the objective comprises a horizontal first reflector or reflector portion (vertical to the optical axis of the objective) and at least one second reflector which is arranged adjacent to this first reflector and which is arranged at an angle of between 0 and 90 degrees to the optical axis, wherein the horizontal first reflector reflects a detection focal point in the direction of the object, and at least the second reflector deflects at least one illumination focal point onto the object.

20. Confocal microscope according to at least one of the preceding claims, characterized in that the beam-deflecting unit arranged on the object side of the objective comprises a horizontal first reflector or reflector portion (vertical to the optical axis of the objective) and at least one second reflector which is arranged adjacent to this first reflector and which is arranged at an angle of between 0 and 90 degrees to the optical axis, wherein the horizontal first reflector reflects ah illumination focal point in the direction of the object, and at least the second reflector deflects at least one detection focal point onto the object.

21. Confocal microscope according to at least one of the preceding claims, characterized in that at least two second reflectors are provided which are preferably located opposite to one another.

22. Confocal microscope according to at least one of the preceding claims, characterized in that the illumination and detection directions in the object form a right angle.

23. Confocal microscope according to at least one of the preceding claims, characterized in that means are provided for fluorescence microscopy.

24. Confocal microscope according to at least one of the preceding claims, characterized in that means are provided for observation of scattered and/or reflected light.
